(19) United States
(12) Patent Application Publication
(10) Pub. No.: US 2017/0073945 A1
(43) Pub. Date: Mar. 16, 2017

(54) Tub faucet

(71) Applicant: Chin-Hua Ho, Changhua City (TW)

(72) Inventor: Chin-Hua Ho, Changhua City (TW)

(21) Appl. No.: 15/361,526

(22) Filed: Nov. 28, 2016

(51) Int. Cl. E03C 1/04; F16K 11/00

(52) U.S. Cl. CPC E03C 1/0408; F16K 19/006; E03C 1/0412

(57) ABSTRACT

A tub faucet in one embodiment includes a hot water inlet for flowing hot water; a cold water inlet for flowing cold water; an outlet communicating with both the hot and cold water inlets; a tee including a first port communicating with the outlet, a second port, and a third port; and a handle for adjusting the volume of hot water mixed with the volume of cold water, flowing the mixed water to the second port or the third port, and turning off the outlet.

### BACKGROUND OF THE INVENTION

1. Field of the Invention

The invention relates to faucets and more particularly to a faucet installed in a tub having improved characteristics.

2. Description of Related Art

There are conventional mixing valves positioned in faucet housings. However, these designs permitted the exiting water to be highly pressurized, which affected the appearance of the water as it exited.

Thus, the need for improvement still exists.

### SUMMARY OF THE INVENTION

It is therefore one object of the invention to provide a faucet assembly comprising a hot water inlet for flowing hot water; a cold water inlet for flowing cold water; an outlet communicating with both the hot and cold water inlets; a tee including a first port communicating with the outlet, a second port, and a third port; and a handle for adjusting the volume of hot water mixed with the volume of cold water, flowing the mixed water to the second port or the third port, and turning off the outlet.

The above and other objects, features and advantages of the invention will become apparent from the following detailed description taken with the accompanying drawings.

### BRIEF DESCRIPTION OF THE DRAWINGS

FIG. 1 is a perspective view of a tub faucet according to a first preferred embodiment of the invention;

FIG. 2 is a perspective view showing the tub faucet connected to a fixed shower head and a hand-held shower head respectively;

FIG. 3 is a perspective view of the tub faucet and adjacent components shown in FIG. 2;

FIG. 4 is a side view showing the tub faucet connected to the shower head which is secured to a wall by two mounting brackets, and the hand-held shower head which is supported by a holder on a pipe respectively;

FIG. 5 is a view similar to FIG. 4 showing spray by the fixed shower head;

FIG. 6 is a view similar to FIG. 4 showing spray by the hand-held shower head;

FIG. 7 is a perspective view of a tub faucet according to a second preferred embodiment of the invention;

FIG. 8 is a longitudinal section view showing the tub faucet of FIG. 7 connected to the fixed shower head via a pipe through the wall;

FIG. 9 is a sectional view showing hot and cold water flows mixed in the tub faucet of FIG. 7;

FIG. 10 is a longitudinal sectional view of the tub faucet of FIG. 9 when the handle is not operated; and

FIG. 11 is a view similar to FIG. 10 showing water flow when the handle is operated.

### DETAILED DESCRIPTION OF THE INVENTION

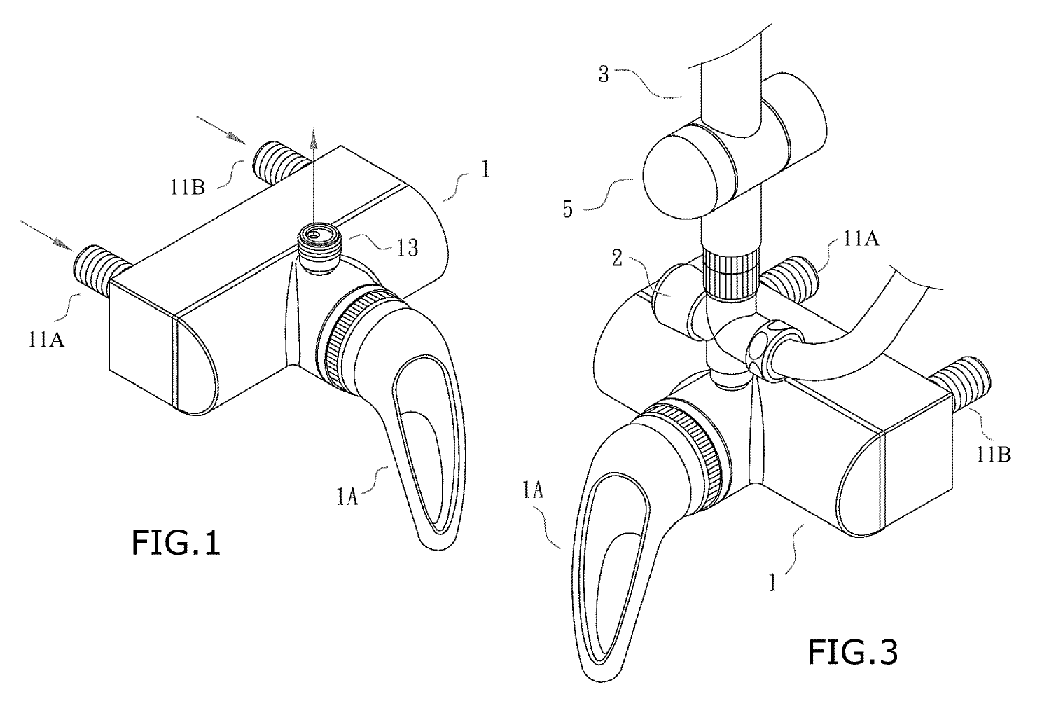

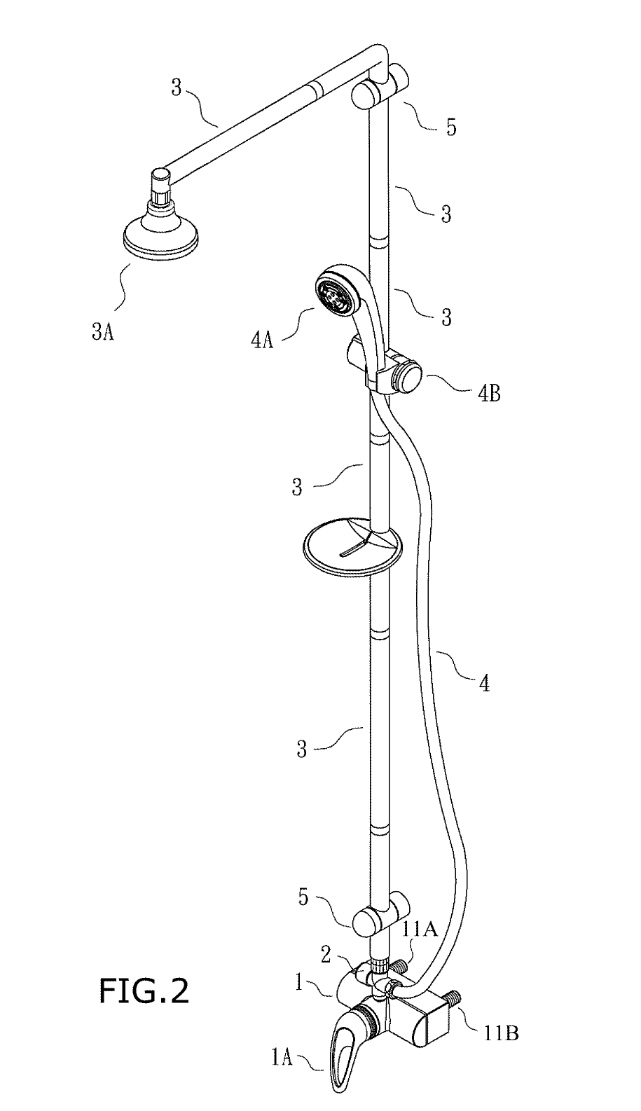

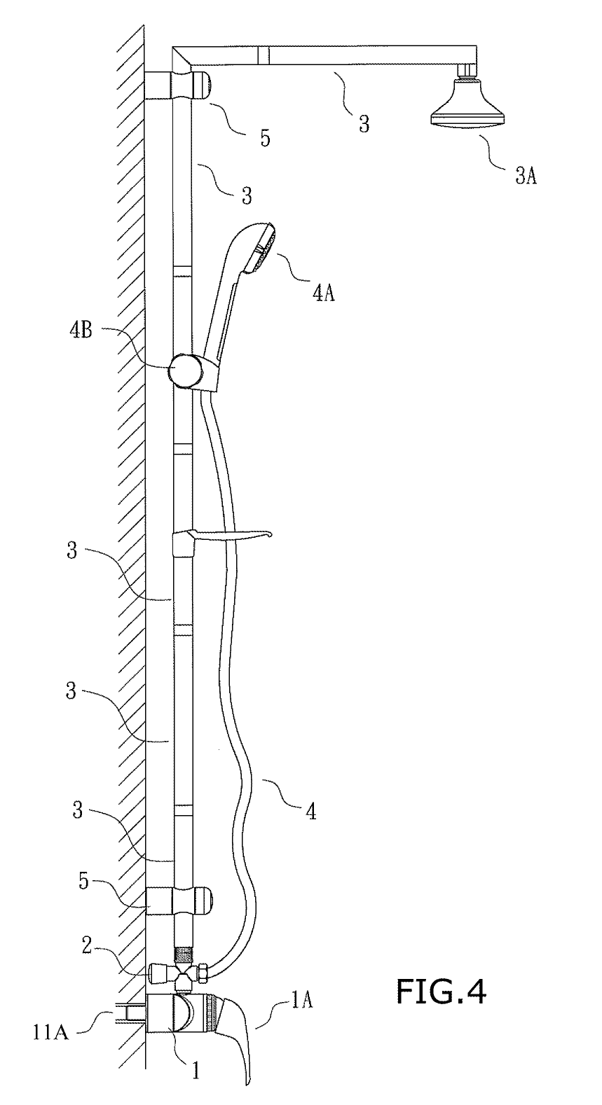

Referring to FIGS. 1 to 6, a tub faucet 1 in accordance with a first preferred embodiment of the invention comprises a handle 1A, a hot water inlet 11A, a cold water inlet 11B, and an outlet 13. The outlet 13 is connected to a first port of a tee 2. A second port of the tee 2 is connected to a flexible hose 4 which in turn is connected to a hand-held shower head 4A. The hand-held shower head 4A is supported by a holder 4B mounted on a pipe 3. A third port of the tee 2 is connected to the pipe 3 which has a distal end connected to a fixed shower head 3A. Further, a plurality of mounting brackets 5 are provided on the pipe 3.

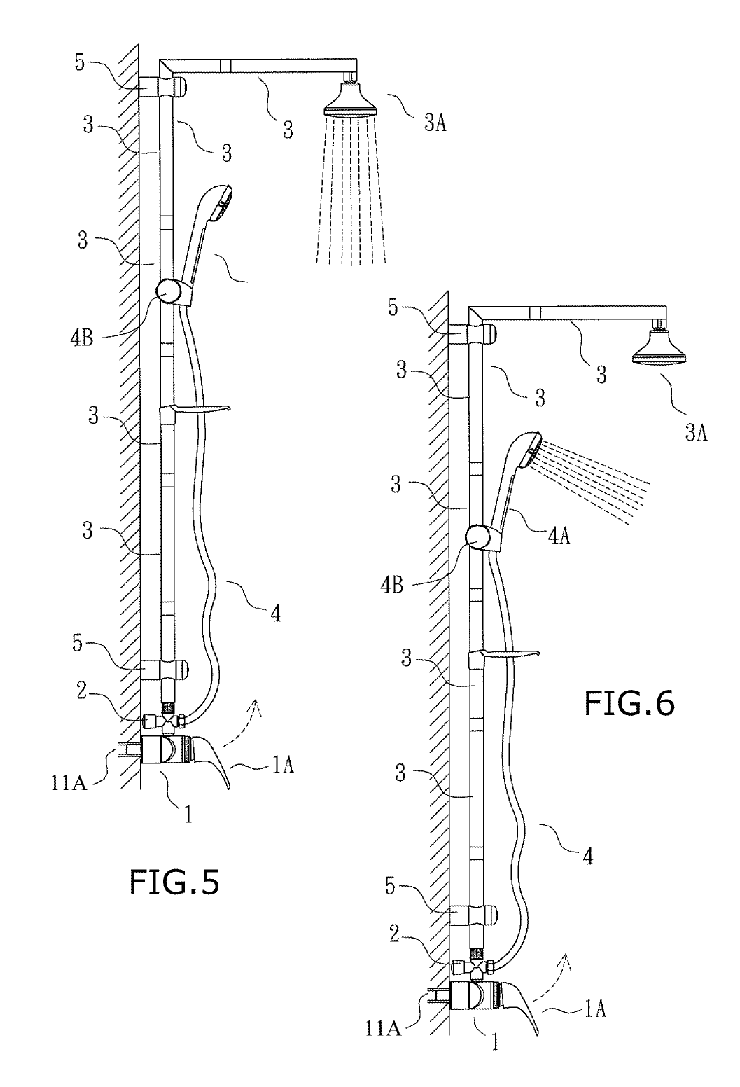

Hot water flowing from the hot water inlet 11A and cold water flowing from the cold water inlet 11B are mixed prior to flowing out of the outlet 13. A manipulation of the handle 1A can adjust the volume of hot water mixed with the volume of cold water. Further, a further manipulation of the handle 1A can divert the mixed warm water to the hand-held shower head 4A (see FIG. 6) for spraying or the fixed shower head 3A (see FIG. 5) for spraying, or turn off the faucet.

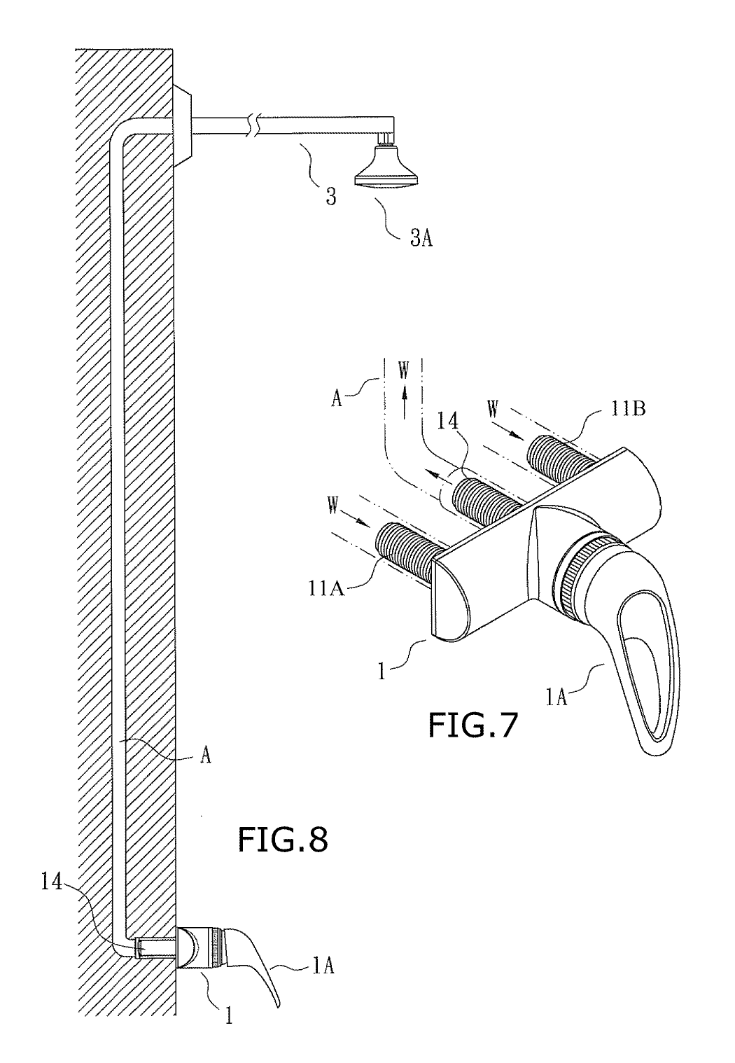

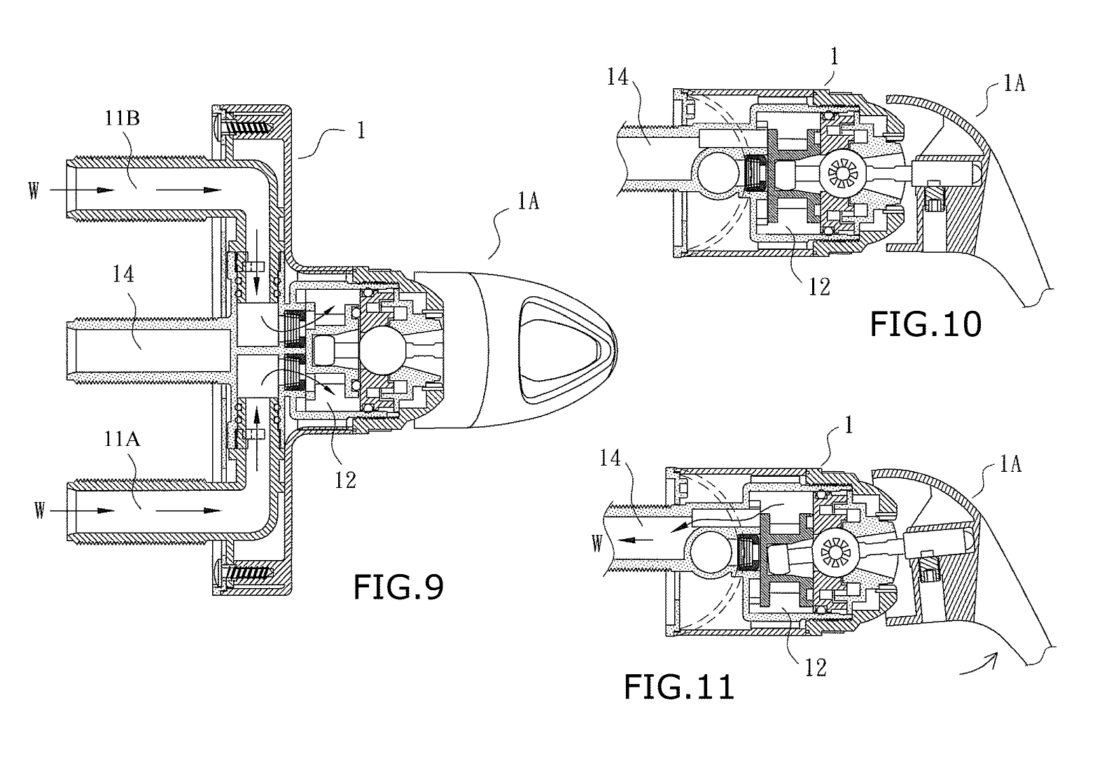

Referring to FIGS. 7 to 11, a tub faucet in accordance with a second preferred embodiment of the invention is shown and comprises a chamber 12, a handle 1A, a hot water inlet 11A, a cold water inlet 11B, and an outlet 14. The outlet 14 is connected to a second pipe A installed in a wall. The second pipe A has an open end connected to the pipe 3 which has an open end connected to a fixed shower head 3A.

Hot water (W) flowing from the hot water inlet 11A and cold water (W) flowing from the cold water inlet 11B are mixed in the chamber 12 prior to flowing out of the outlet 14. A manipulation of the handle 1A can adjust the volume of hot water mixed with the volume of cold water. Further, a further manipulation of the handle 1A can flow the mixed warm water to the fixed shower head 3A for spraying or not.

While the invention has been described in terms of preferred embodiments, those skilled in the art will recognize that the invention can be practiced with modifications within the spirit and scope of the appended claims.

What is claimed is:

1. A faucet assembly comprising:
a hot water inlet for flowing hot water;
a cold water inlet for flowing cold water;
an outlet communicating with both the hot and cold water inlets;
a tee including a first port communicating with the outlet, a second port, and a third port; and
a handle for adjusting the volume of hot water mixed with the volume of cold water, flowing the mixed water to the second port or the third port, and turning off the outlet.

2. A faucet assembly comprising:
a hot water inlet for flowing hot water;
a cold water inlet for flowing cold water;
a chamber for mixing the hot water with the cold water;
an outlet communicating with the chamber; and
a handle for adjusting the volume of hot water mixed with the volume of cold water, and flowing the mixed water to a predetermined destination or not.
